(19) United States
(12) Patent Application Publication
(10) Pub. No.: US 2011/0216360 A1
(43) Pub. Date: Sep. 8, 2011

(54) IMAGE FORMING APPARATUS AND METHOD OF CONTROLLING OUTPUT THEREOF

(75) Inventors: Young-ei CHO, Seoul (KR); So-young LEE, Seoul (KR); Hyuck KIM, Yongin-si (KR)

(73) Assignee: Samsung Electronics Co., Ltd., Suwon-si (KR)

(21) Appl. No.: 13/038,646

(22) Filed: Mar. 2, 2011

(30) Foreign Application Priority Data
Mar. 3, 2010 (KR) 10-2010-0019106

(51) Int. Cl. G06F 3/12

(52) U.S. Cl. 358/1.15

(57) ABSTRACT

An image forming apparatus and method control an output by using a preview identifying an output result. An output of a document is controlled after identifying a result of the output by using a sample image preview and a real image preview of the document with an option set.

### CROSS-REFERENCE TO RELATED APPLICATIONS

This application claims priority from Korean Patent Application No. 10-2010-0019106, filed on Mar. 3, 2010 in the Korean Intellectual Property Office, the disclosure of which is incorporated herein by reference in its entirety.

### BACKGROUND OF THE INVENTION

1. Field of the Invention

Apparatuses and methods consistent with the exemplary embodiments relate to an image forming apparatus and a method of controlling an output thereof, and more particularly, to an image forming apparatus and a method of controlling an output thereof which controls an output by using a preview identifying an output result.

2. Description of the Related Art

An image forming apparatus may include a digital/analog photocopier, a printer, a facsimile, a scanner outputting image data or a multi-function peripheral (MFP) which performs copying, printing, scanning, fax sending/receiving, and file transmitting functions.

As the image forming apparatus has become more sophisticated, the image forming apparatuses have been developed to include various options that can be set to affect the image output. Conventionally, if the image forming apparatus outputs a document via an available operation, including one of the copying, printing, scanning, fax sending/receiving, and file transmitting operations, a user may identify whether a set option is appropriate only after the output operation is completed.

As more and more image forming apparatuses employ many functions and complicated user interfaces (UIs), a user may not easily anticipate a result of an output reflecting one or more options set for a document if the user outputs the document by manipulating an operation panel equipment of the image forming apparatus. Therefore, it is desired to develop an approach to provide the user with a convenient way to anticipate the result of the output before outputting the document to a recording medium.

### SUMMARY OF THE INVENTION

Accordingly, one or more exemplary embodiments provide an image forming apparatus and a method of controlling an output thereof which controls an output of a document after identifying a result of the output by using a sample image preview and a real image preview of the document with an option set.

Additional utilities and features of the present general inventive concept will be set forth in part in the description which follows and, in part, will be obvious from the description, or may be learned by practice of the present general inventive concept.

The foregoing and/or other utilities and features of the present general inventive concept may be achieved by providing a method of controlling an output of an image forming apparatus, the method including: loading a document through a scan unit, setting an option for the document through an operation panel unit, displaying a sample image preview corresponding to a sample image on a display unit by using the sample image reflecting the set option, generating a document image by scanning the document, generating a real image by applying the set option to the document image, and displaying on the display unit a real image preview corresponding to the real image.

The method may further include outputting the real image, and the outputting may include at least one of: printing the real image on a recording medium, transmitting an e-mail with the real image attached thereto to an external device, transmitting by fax the real image to a receiving fax machine, and transmitting the real image to an external server.

At least one of the sample image and the real image may be scaled to be consistent with a display area of the display unit in which a preview is displayed.

The scan unit may include at least one of a scan glass and an auto document feeder which load the document thereon.

The method may further include selecting a function corresponding to at least one of the printing, the transmitting of an e-mail, the transmitting by fax and the transmitting to the external server.

The outputting may include outputting the real image corresponding to the selected function.

The displaying the sample image preview may include processing the sample image according to the set option.

The display unit may display at least one of the sample image preview and the real image preview in a pop-up window.

The method may further include providing at least one of the sample image preview and the real image preview to an external device.

The foregoing and/or other utilities and features of the present general inventive concept may be achieved by providing a method of controlling an output of an image processing apparatus, the method including: determining whether to scan a document, receiving a selection to set an option for the document, displaying a sample image preview corresponding to a sample image on a display unit by using the sample image having the set option if the document is not scanned yet, generating a real image by applying the set option to a document image generated by scanning the document, and displaying on the display unit a real image preview corresponding to the real image if the document is scanned.

The method may further include outputting the real image corresponding to at least one of functions which are used to output the real image.

The displaying the real image preview may include processing the sample image according to the set option.

The foregoing and/or other utilities and features of the present general inventive concept may be achieved by providing an image forming apparatus including: a scan unit which generates a document image by scanning a document, an interface which is connected to an external device, an operation panel unit which receives an input to set an option for generating the document image, a storage unit which stores therein a sample image corresponding to the set option and the document image, an image processor which processes the document image according to the set option which is input through the operation panel unit to generate a real image, a display unit which displays thereon a preview using the sample image and the real image, and a controller which controls the display unit to selectively display the preview depending on whether the document is scanned.

The image forming apparatus may further including an output unit which outputs the real image, and the output unit may include at least one of: an image forming unit which prints the real image on a recording medium, an e-mail transmitter which transmits an e-mail with the real image attached thereto to an external device, a fax unit which transmits by fax the real image to a receiving fax machine, and a file transmitter which transmits the real image to an external server.

The scan unit may include at least one of a scan glass on which the document is manually fed, and an auto document feeder which automatically feeds the document.

At least one of the sample image preview and the real image preview may be supplied to an external device through the interface.

The display unit may include a preview area in which at least one of the sample image and the real image is displayed, and at least one of the sample image and the real image may be scaled according to the preview area.

The foregoing and/or other utilities and features of the present general inventive concept may be achieved by providing a method of controlling an output of an image forming apparatus, the method including: loading a document through a scan unit, displaying on a display unit a sample image preview corresponding to a sample image by using a prestored sample image, generating a document image by scanning the document, generating a real image by using the document image, and displaying on the display unit a real image preview corresponding to the real image.

At least one of the sample image preview and the real image preview may be displayed as a default set for the image forming apparatus.

The method may further include outputting the real image, and the outputting may include at least one of: printing the real image on a recording medium, transmitting the real image as an attachment to an e-mail to an external device, transmitting the real image by fax to a receiving fax machine, and transmitting the real image to an external server.

The method may further include selecting a function corresponding to at least one of the printing, the transmitting as the attachment to the email, the transmitting by fax and the transmitting to the external server, and the outputting may include outputting the real image corresponding to the selected function.

The foregoing and/or other utilities and features of the present general inventive concept of the general inventive concept may be achieved by providing a method of controlling an output of an image forming apparatus, the method including: loading a document through a scan unit, generating a document image by scanning the document, generating a real image based on the document image, and displaying on a display unit a real image preview corresponding to the real image, and outputting the real image.

The method may further include receiving an input for an option of the document through an operation panel unit, and the real image may be generated by applying the set option thereto.

### BRIEF DESCRIPTION OF THE DRAWINGS

The above and/or other utilities and features of the present general inventive concept of the present general inventive concept will become apparent and more readily appreciated from the following description of the exemplary embodiments, taken in conjunction with the accompanying drawings, in which:

FIG. 1 is a block diagram of an image forming apparatus according to an exemplary embodiment of the present general inventive concept;

FIG. 2 illustrates a configuration of the image forming apparatus according to the exemplary embodiment of the present general inventive concept;

FIG. 3 illustrates an operation controlling unit including an operation panel equipment and a display unit including a touch panel according to the exemplary embodiment of the present general inventive concept;

FIG. 4 is a flowchart of a method for controlling an output of the image forming apparatus according to the exemplary embodiment of the present general inventive concept;

FIGS. 5A to 5D illustrate an example of a sample image preview according to the exemplary embodiment of the present general inventive concept;

FIGS. 6A and 6B illustrate an example of a document and a real image preview corresponding to a document image according to the exemplary embodiment of the present general inventive concept;

FIG. 7 illustrates an example of a real image preview which is transmitted by fax according to the exemplary embodiment of the present general inventive concept;

FIG. 8 illustrates an example of a real image preview which is transmitted by e-mail according to the exemplary embodiment of the present general inventive concept;

FIG. 9 illustrates an example of a real image preview which is transmitted by a file according to the exemplary embodiment of the present general inventive concept; and

FIG. 10 is a flowchart of a method for controlling an output of an image forming apparatus according to another exemplary embodiment of the present general inventive concept.

### DETAILED DESCRIPTION OF EXEMPLARY EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

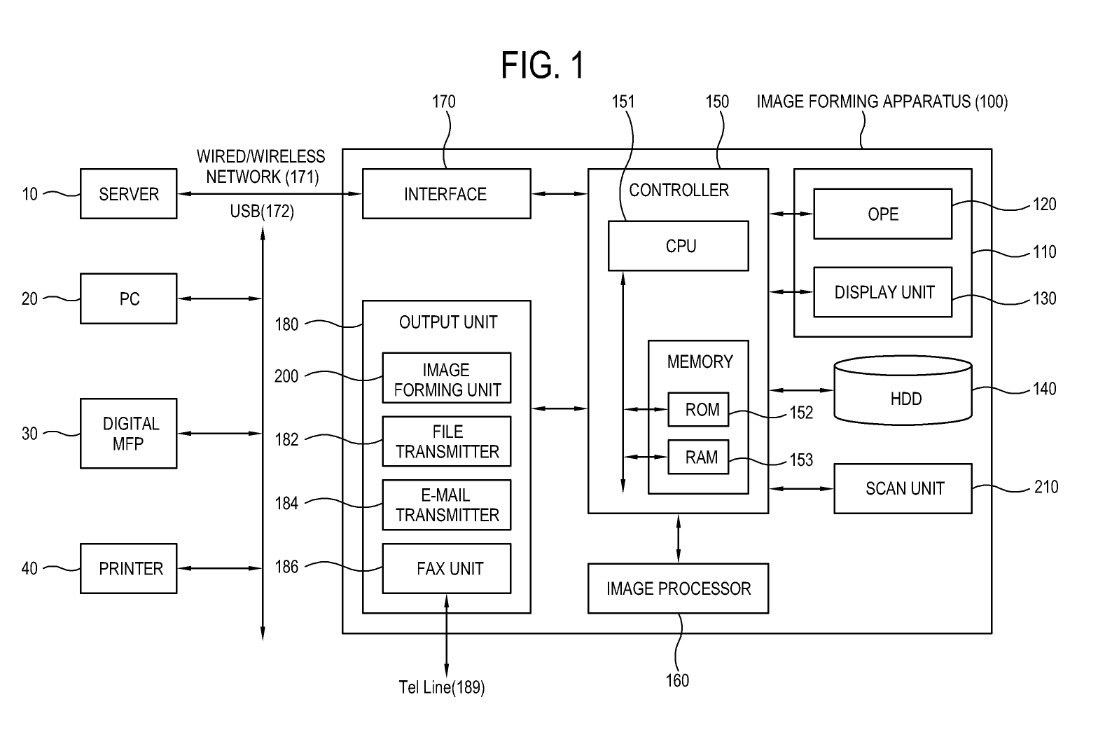

FIG. 1 is a block diagram of an image forming apparatus according to an exemplary embodiment of the present general inventive concept.

An image forming apparatus 100 according to the exemplary embodiment of the present general inventive concept is connected to a wired/wireless network 171, and may also be connected to a universal serial bus (USB) 172. The wired/wireless network 171 and the USB 172 are capable of carrying various types of data, and thus may enable the image forming apparatus to communicate data with other devices or components. The image forming apparatus 100 may be connected to at least one server 10 and at least one personal computer (PC) 20 through the wired/wireless network 171 and the USB 172. Also, the image forming apparatus 100 may be connected to at least one digital multi-function peripheral (MFP) 30, and at least one printer 40, for example, via the USB 172. The digital MFP 30 and the printer 40 are included in the image forming apparatus 100. The MFP 30 may be a device that can perform various functions that can be carried by separate peripheral devices. One example of the MFP 30 may include a printer/scanner combination device or a printer/scanner/facsimile combination device.

Referring to FIG. 1, the image forming apparatus 100 may scan a document, convert the document into image data and output the image data to a recording medium. Examples of the recording medium may include paper, plastic sheet, and any other medium with a printable surface. The image forming apparatus 100 is connected to the wired/wireless network 171, the USB 172 and a telephone (Tel) line 189. Hence, the image forming apparatus 100 may transmit scanned image data to the outside through the wired/wireless network 171, the USB 172 or the telephone line 189 or store the scanned image data or may store image data received from the outside in a hard disk drive (HDD) 140 by a control of a controller 150 (to be described later).

The image forming apparatus 100 includes a scan unit 210, an operation control unit including an operation panel unit or equipment (OPE) 120 and a display unit 130, the HDD 140, the controller 150, an image processor 160, an interface 170, and an output unit 180 which includes at least one of an image forming unit 200, a file transmitter 182, an e-mail transmitter 184 and a fax unit 186.

The OPE 120 receives a user's input to control operation of the image forming apparatus 100. The display unit 130 displays thereon information about a current status of the image forming apparatus 100 and a user's input transmitted by the OPE 120. A sample image preview corresponding to a sample image of a document and a real image preview corresponding to a real image of the document are displayed on the display unit 130 for a user to identify a result of an output.

The display unit 130 according to the exemplary embodiment of the present general inventive concept may include a touch panel, which enables a user to control operation of the OPE 120 and displays the display unit 130.

The HDD 140 stores therein a sample image for a sample image preview, and a document image of a document scanned by the scan unit 210. The sample image may be added, deleted, adjusted or updated by a change of an option set for the function of the image forming apparatus 100. The HDD 140 may also store various types of data, including documents, digital media, operation history, setting information, user information, etc.

The document image of a scanned document may also be referred as the image data of the scanned image.

Image data which corresponds to a document scanned by the scan unit 210 may be processed by the image processor 160, which may be controlled by the controller 150. This image data may be output to a recording medium or transmitted to an external server or transmitted to the outside of the image forming apparatus 100 by e-mail or fax.

Received image data may be stored in the HDD 140 or any other types of storage media by a control of the controller 150. If the image data is to be output to a recording medium, at least one of a sample image preview and a real image preview of the image data may be displayed such that a user may identify the result of the output before outputting the image data to the recording medium and then output the image data.

The fax unit 186 compresses the image data corresponding to the scanned document and transmits the compressed image data by fax through the telephone line 189 according to a control of the controller 150. The transmitted image data may be stored in the HDD 140. The compressed image data which is received from the outside through the telephone line 189 is decompressed by the controller 150 and output to the image forming unit 200 or stored in the HDD 140 or output to the output unit 180 according to a manipulation of the OPE 120. Also, the fax unit 186 may not compress the image data corresponding to the scanned document, and thus transmit the uncompressed image data. In this example, the controller 150 may determine whether to compress the image data or not before transmission.

The image forming apparatus 100 according to the exemplary embodiment of the present general inventive concept is connected to the server 10 and the PC 20 through the interface 170, and may output print data received from the server 10 or the PC 20 to the image forming unit 200 according to a control of the controller 150 or store the print data in the HDD 140.

The controller 150 may include a central processing unit (CPU) 151, a read only memory (ROM) 152 storing therein a control program, and a random access memory (RAM) 153 recording input data or relevant operations. The controller 150, the CPU 151, the ROM 152, and the RAM 153 may be connected with one another through a bus. The controller 150 controls the OPE 120, the display unit 130, the HDD 140, the scan unit 210, the image processor 160, the interface 170 and the output unit 180.

The controller 150 which is connected to the OPE 120 receiving a user input controls feeding and returning operations of a recording medium, a motor relating to driving an optical system for scanning, and at least one clutch and a solenoid. That is, the controller 150 monitors and controls the operation of the image forming apparatus 100. Although not illustrated in FIG. 1, the controller 150 may be a plurality of controllers 150. If there are a plurality of controllers 150, each of the controllers 150 may independently control the scan unit 210, the OPE 120, the display unit 130 and the image forming unit 200 of the image forming apparatus 100.

The image processor 160 receives an image signal output from the scan unit 210, processes the input image signal according to an option set by a user's input through the OPE 120 and generates image data.

The interface 170 may be connected to at least one server 10 and at least one PC 20 through the wired/wireless network 171 and the USB 172. The interface 170 may also be connected to at least one digital MFP 30 and at least one printer 40.

The output unit 180 includes at least one of the image forming unit 200 to print image data on a recording medium, the file transmitter 182 to transmit image data to an external server, an e-mail transmitter 184 to transmit an image with image data attached thereto to an external device by e-mail, and the fax unit 186 to transmit the image data to a receiving fax machine. In the output unit 180, the file transmitter 182 and the e-mail transmitter 184 may transmit image data to the server 10, the PC 20, the digital MFP 30 or the printer 40 through the interface 170 by a control of the controller 150.

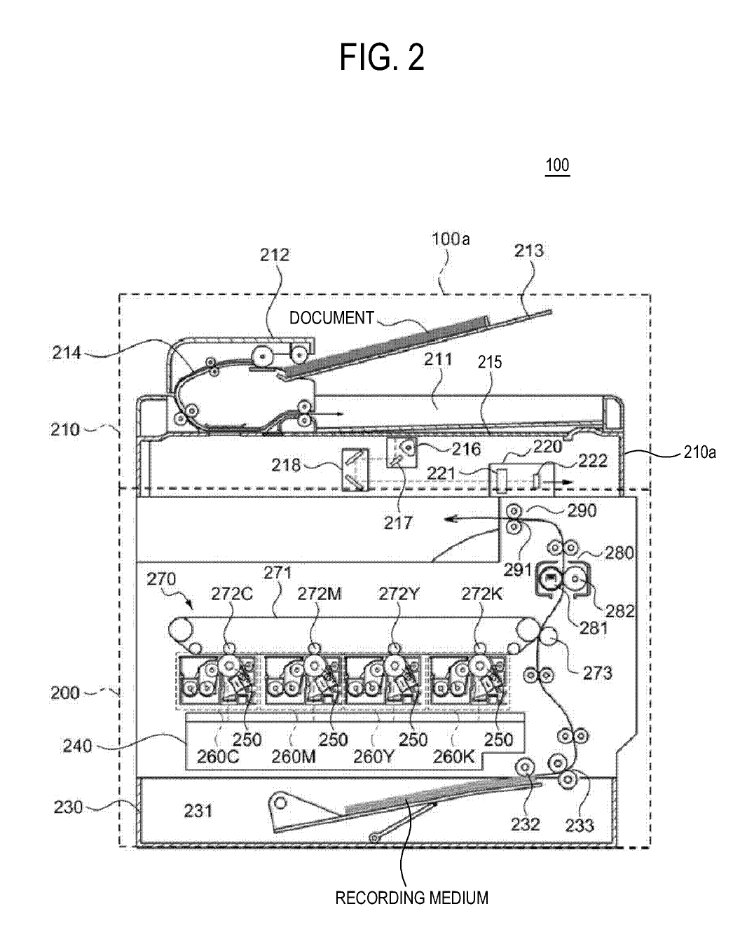

FIG. 2 illustrates a configuration of the image forming apparatus 100 according to the exemplary embodiment of the present general inventive concept.

The image forming apparatus 100 includes the scan unit 210 to perform scans and the image forming unit 200 to print images. In this example, the scan unit 210 and the image forming unit 200 are enclosed in a housing 100a.

The scan unit 210 includes a cover 211 including an auto document feeder (ADF) 212 and a scan unit main body 210a. The ADF 212 automatically feeds a document, including at least one page. For example, when a document with multiple pages is loaded, the ADF 212 may automatically feed the document one page at a time such that the multiple pages of the document may be fed automatically without manually loading each page of the document.

The ADF 212 may be replaced by a duplex auto document feeder (DADF) which may feed duplex pages, which are front and back sides, of a document. For example, DADF may be configured to scan both sides (e.g. the front and back sides) of a page of the document.

A document which is loaded on a document feeder 213 is automatically fed page by page by the ADF 212 along a feeding path 214, and then is scanned and discharged.

The cover 211 is coupled to the scan unit main body 210a, and opens to expose an upper surface of the scan unit main body 210a and closes to cover the upper surface of the scan unit main body 210a. The scan unit main body 210a may include a scan glass 215 to load thereon a document including at least one page, for manual feeding. In one embodiment, the cover 211 may be rotatably coupled to the scan unit main body 210a such that the cover 211 pivotably opens and closes from the scan unit main body 210a.

The scan unit main body 210a includes a light source 216 to scan a document or any other media, a plurality of mirrors 217 and 218 to reflect light from the light source 216 to an image sensor 222 and at least one image formation lens 221 to form an image in the image sensor 222 with the reflected light. The light source 216 and the plurality of mirrors 217 and 218 may be accommodated in a mobile optical system (not shown), which scans a document in a fixed position or by reciprocation by using a driving motor or a pulley.

An image sensor unit 220 includes the image formation lens 221, the image sensor 222 and an image sensor drive (not shown) which drives the image sensor 222. An output of an image signal by the image sensor 222 with respect to reflected light is converted into a digital signal (e.g., a 8-bit digital signal), which is then input to the controller 150. The digital signal converted from the output of the image signal may vary among, for example, 8 bits, 16 bits, 32 bits and 64 bits, depending on the performance of the image forming apparatus 100.

The image sensor 222 may include one of a charge coupled device (CCD) sensor and a complementary metal oxide semiconductor (CMOS) sensor.

The image forming unit 200 which is included in the output unit 180 of FIG. 1 may include a laser beam printer (LBP) or an inkjet printer according to a print type. The image forming unit 200 according to the present exemplary embodiment includes a laser beam printer.

The image forming unit 200 includes a feeding unit 230, a light scanning unit (LSU) 240, a developing unit 260 including photo conductors 250C, 250M, 250Y and 250K, a transfer unit 270, a fusing unit 280 and a discharging unit 290. The foregoing units may vary depending upon a type of print of the LBP such as a mono print and a color print of the LBP. The foregoing units may also vary depending on a developing method (multi pass or single pass) in a color printer and a transfer method (direct transfer and indirect transfer).

The feeding unit 230 includes a cassette 231 to load a recording medium thereon, a pickup roller 232 to pick up a recording medium from the cassette 231 and at least one feed roller 233 to feed the picked-up recording medium.

There is one feeding unit 230 in the present exemplary embodiment. However, in another embodiment, a plurality of feeding units including the feeding unit 230 may be mounted in the image forming apparatus 100 and a recording medium may be loaded on each of the feeding units 230 to be fed.

The LSU 240 scans at least one light beam corresponding to an image signal to a plurality of photo conductors 250C, 250M, 250Y and 250K and forms an electrostatic latent image on a surface of the plurality of photo conductors 250C, 250M, 250Y and 250K. The LSU 240 may include at least one laser diode (LD) (not shown), at least one polygon mirror (not shown), at least one mirror (not shown) or at least one lens (not shown), a micro electro mechanical system (MEMS) mirror (not shown) or a combination thereof.

The developing units 260C, 250M, 250Y and 260K supply a developer in different colors of cyan, magenta, yellow and black, respectively, to the plurality of photo conductors 250 and form a visible image.

In the present exemplary embodiment, the developing units 260C, 250M, 250Y and 260K will be referred collectively as the developing unit 260, and the photo conductors 250 will be referred collectively as the photo conductor 250. The developing unit 260 will be described as an example and such explanation is applicable to the developing units 260C, 260M, 260Y and 260K. The developing units 260C, 260M, 260Y and 260K according to the present general inventive concept includes four colors, but not limited thereto, and may include five or more developing units. Further, in another embodiment, although not shown, if the image forming unit 200 is only for black-and-white printing, then only the developing unit 260K for black color may be present.

The developing unit 260 includes a charger (not shown) which uniformly charges the respectively photo conductor 250, a developer supply roller (not shown) which supplies a developer to a developing roller (not shown), a developing roller (not shown) which receives the developer supplied by the developer supply roller and supplies the received developer to an electrostatic latent image of the photo conductor 250 formed by the LSU 240 and then forms a visible image, a developer cleaner (not shown) which removes the developer remaining in the photo conductor 250 after the visible image of the photo conductor 250 is transferred to a transfer belt 271, a waste toner container (not shown) which contains the developer removed by the developer cleaner, and an electric discharging unit (not shown) which removes an electric potential remaining in the photo conductor 250.

The transfer unit 270 includes the transfer belt 271, first transfer rollers 272C, 272M, 272Y and 272K which transfer a visible image formed in the respective photo conductors 250 to the transfer belt 271, and a second transfer roller 273 which transfers to a recording medium an image having a plurality of developers overlapping thereon. In the present exemplary embodiment, an indirect transfer method is described, but the present exemplary embodiment is also applicable to a direct transfer method in which a recording medium is fed between the plurality of photo conductors 250 and the respective first transfer rollers 272C, 272M, 272Y and 272K and an overlapping image is transferred to the recording medium.

The fusing unit 280 includes at least one heat roller 281 and at least one pressure roller 282, and fuses an image transferred to a recording medium by heat of the heat roller 281 and pressure of the pressure roller 282.

The discharging unit 290 includes at least one roller 291, and discharges a recording medium having an image fixed thereon. The image forming apparatus 100 according to the present general inventive concept may have a duplex path (not shown). The duplex path may enable feeding a document again after printing on a front side of the document to provide a duplex print function, e.g. printing on an opposite side of the document and then discharging the document, instead of discharging the document through the discharging unit 290 after printing on a front side of the document.

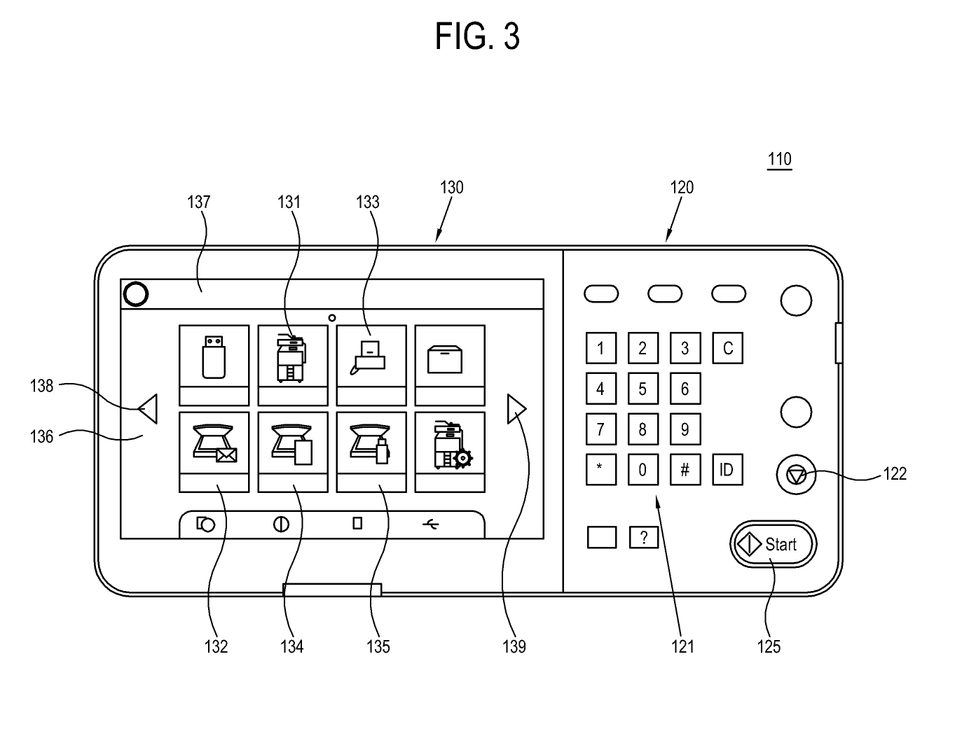

FIG. 3 illustrates the operation controlling unit 110 including the OPE 120 and the display unit 130 including a touch panel according to the exemplary embodiment of the present general inventive concept.

FIG. 3 illustrates a UI screen 137 displayed on the displayed unit 130 that provides a user interface for operation of the image forming apparatus 100. In this example, the UI screen 137 includes a home window 136 which is displayed on the display unit 130 when power is supplied to the image forming apparatus 100 at the beginning and a booting is completed.

The image forming apparatus 100 may perform at least one of copying, printing, scanning, fax sending and file transmitting functions, and the function is displayed on the display unit 130. A user may select at least one of the functions through the OPE 120 and input an option for the performance of the selected function.

The OPE 120 includes a numeric keypad 121 which is used to input numbers such as the number of copies, a stop button 122 to stop functions or operations, a start button 125 to execute the function with the option and/or another function button(s) including various functions.

The display unit 130 displays functions such as copy 131, transmit file 132, send fax 133, scan 134, and scan-to-USB memory 135 on the home window 136, and at least one function which is selected through the OPE 120 is reflected on a user interface (UI) screen by changing the UI to distinguish itself from other functions and to perform the selected function. Further, the left arrow 138 and the right arrow 139 may be selected to display different functions or windows.

An option which is required to perform the selected function may be displayed in the changed UI screen, and the option which is selected through the OPE 120 may be displayed. The display unit 130 may display thereon a status of the image forming apparatus 100 such as error, preparation and operation, and residual amount information of consumables.

In the present exemplary embodiment, the OPE 120 and the display unit 130 are described separately. However, if the display unit 130 is a touch panel, the display unit 130 may be manipulated like the OPE 120 through the touch panel. Otherwise, the image forming apparatus 100 may include the touch panel without the OPE 120.

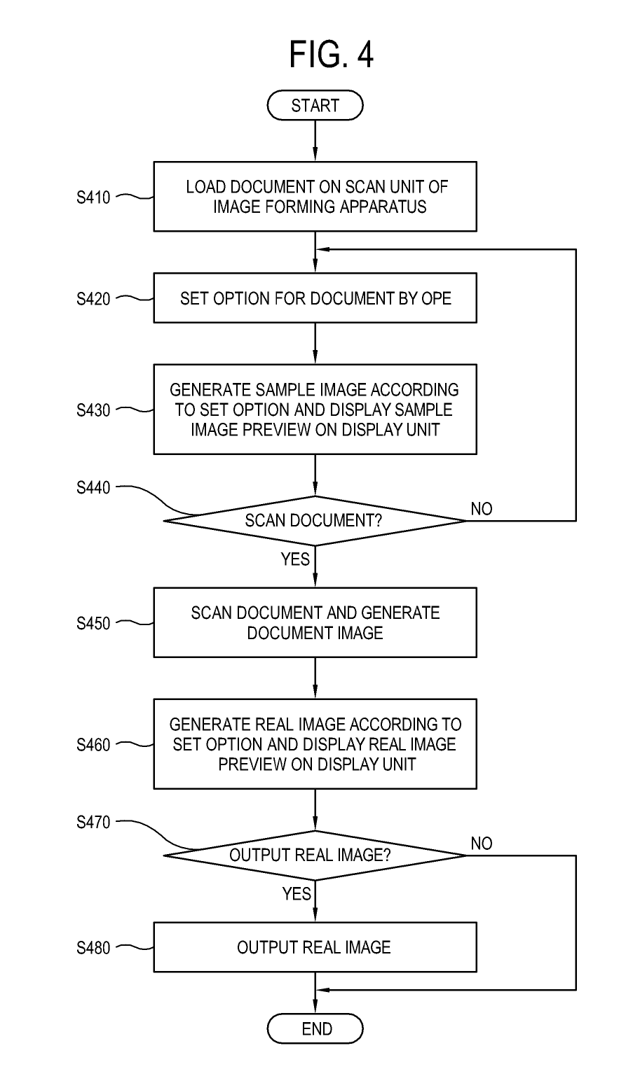

FIG. 4 is a flowchart of a method for controlling an output of the image forming apparatus 100 according to the exemplary embodiment of the present general inventive concept.

Referring to FIG. 4, a document including one or more pages of the document is loaded on the document feeder 213 of the scan unit 210 at operation S410. The document may be loaded on the document feeder 213 of the ADF 212 or loaded on the scan glass 215 at operation S410. The loading of the document may be detected by a paper detecting sensor (not shown) or through the image sensor unit 220 which is described above with reference to FIG. 2.

At least one function which is displayed on the display unit 130 of the image forming apparatus 100 can be selected through the OPE 120, for example, via a user input. The UI screen is displayed on the display unit 140 corresponding to the selected function. Thus, the UI screen may change to correspond to the selection of the function.

Further, the option for the output of the image forming apparatus 100 may be set by a user through the OPE 120 or the touch panel at operation S420. The output of the image forming apparatus 100 may be an image output generated based on an image data from the scanned document and options for the image data. Thus, the output may include an image file and an image printed on a recording medium, reflecting the options.

Then, to help identify the result of the output of the image forming apparatus 100, a sample image is generated according to the set option (and stored in the HDD 140), and the sample image preview corresponding to the sample image stored in the HDD 140 reflecting the set option is displayed in an area of the display unit 130 at operation S430. The sample image may be any type of image to which the set option can be applied, such that a user can view the sample image preview to visualize the effect of the set option on an image. If the sample image stored according to the set option is selected or the image processing is required for the selected sample image, the sample image preview corresponding to the sample image processed by the image processor 160 by the control of the controller 150 is displayed on the display unit 130.

An example of the image processing may include at least one of enlargement and reduction of the sample image, and displaying of multiple pages of documents in a single display (e.g., according to N-up which is the number of pages N displayed in a single display), but not limited thereto.

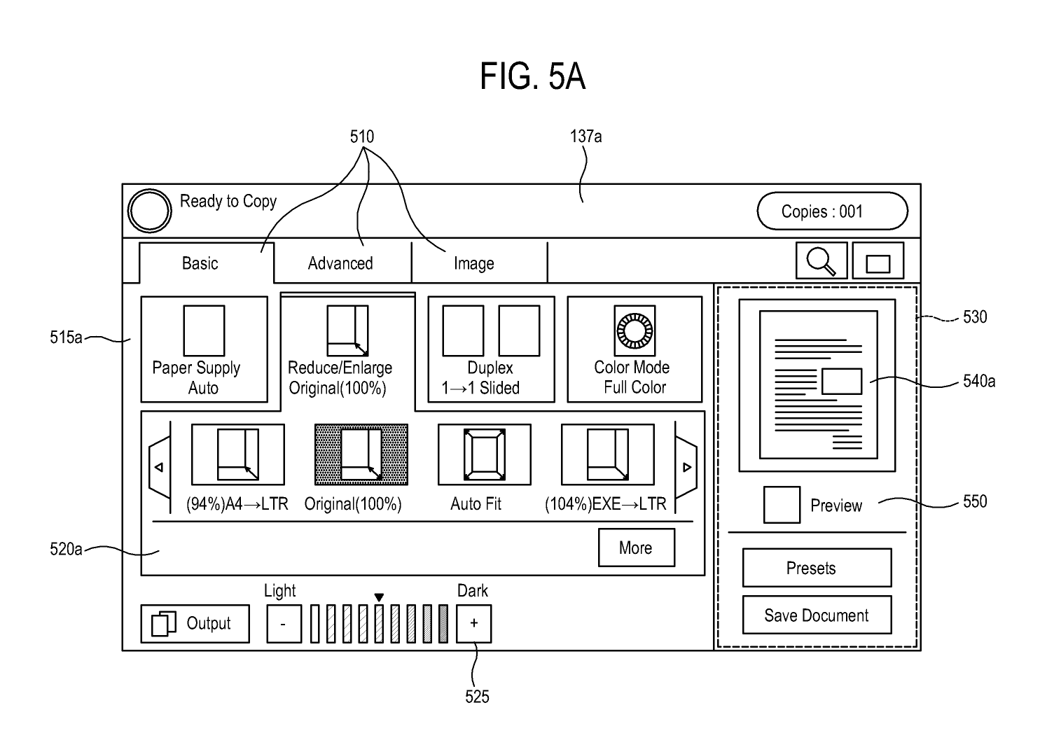

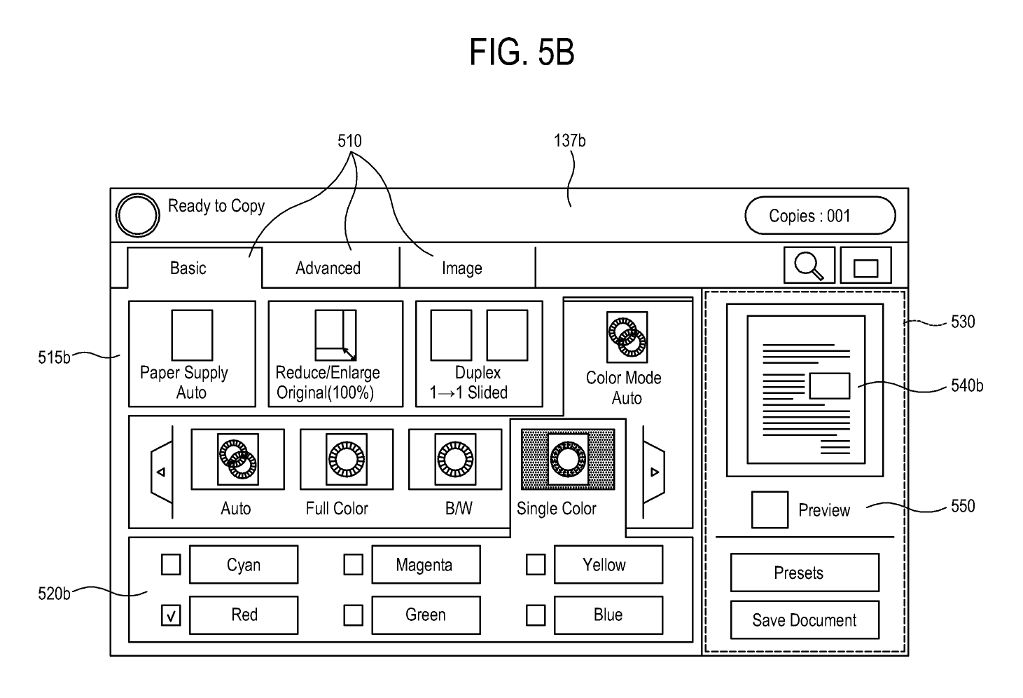

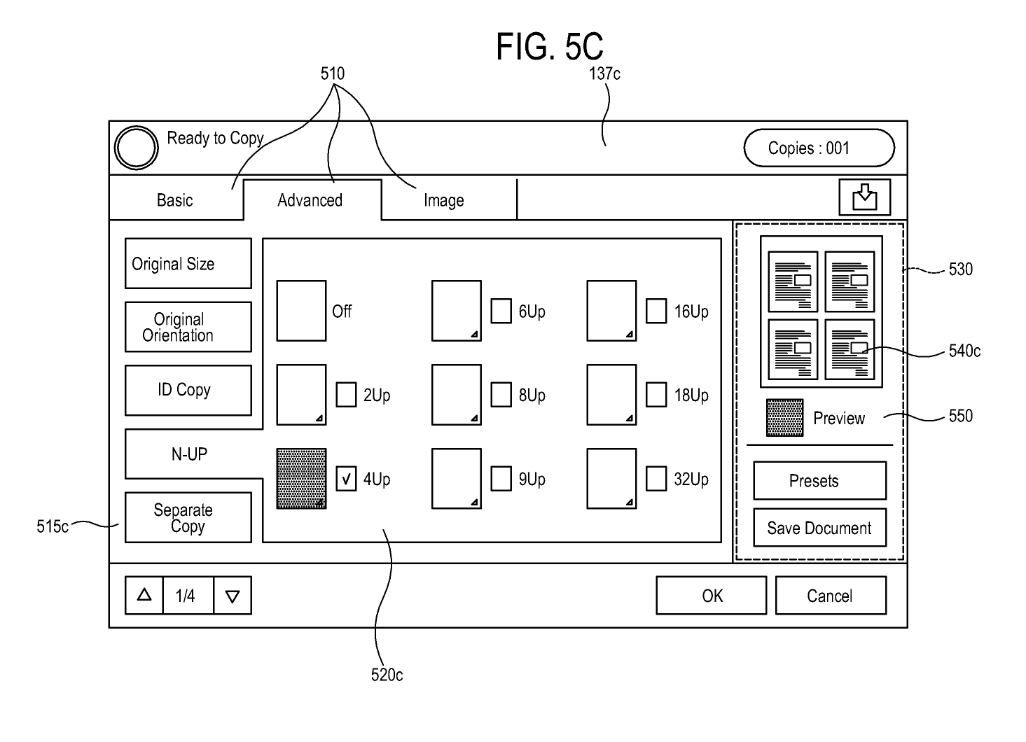

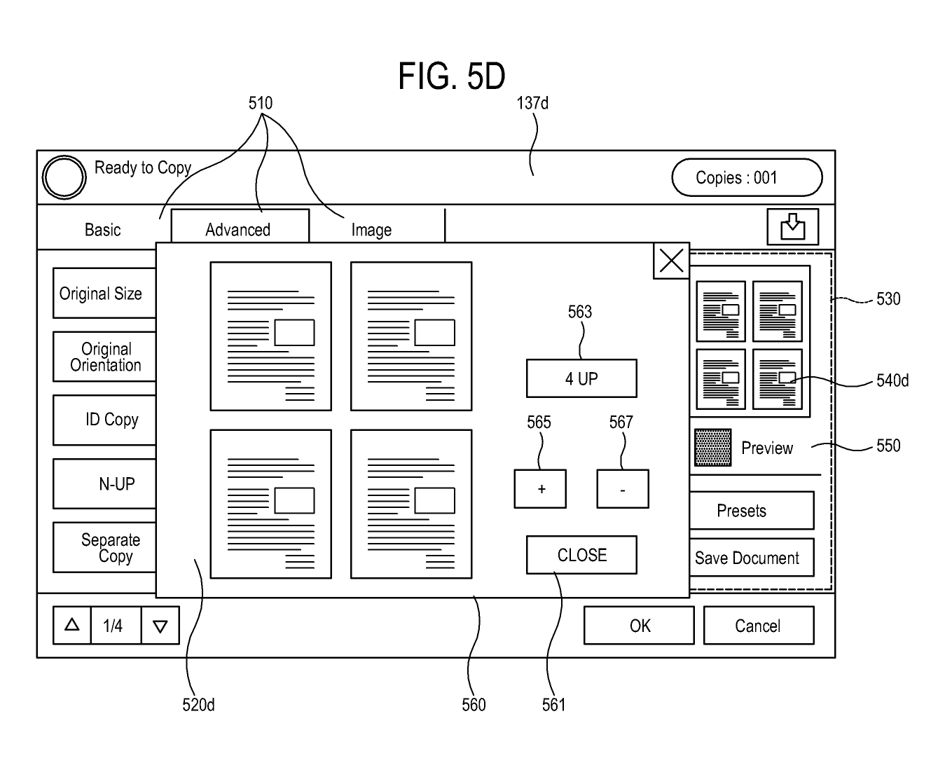

FIGS. 5A to 5D illustrate an example of the sample image preview according to the exemplary embodiment of the present general inventive concept.

As illustrated in FIGS. 5A-5D, a UI screen 137 of the display unit 130 includes a tab area 510 including a basic tab, an advanced tab and an image tab, an option area 520 exposing at least one option included in each tab area 510, and a preview display area 530 displaying a sample image preview and a real image preview as shown in FIGS. 5A to 5D. Note that the UI screens 137a-137d for FIGS. 5A-5D are collectively referred as 137, and the option areas 520a-520d for FIGS. 5A-5D are collectively referred as the option area 520.

The preview display area 530 includes a preview area 540, and a preview selection menu 550 which is provided to select a display/non-display of the sample image preview and the real image preview in the preview area 540. Note that the preview areas 540a-540d for FIGS. 5A-5D are collectively referred as the preview area 540. The location of the preview display area 530 may be one of top, bottom, left and right sides of the display unit 130 and may be enlarged or reduced. In addition, the preview display area 530 may be displayed in a pop-up window.

If a copy function to make a copy of the document is selected from the display unit 130, the UI screen is changed and displays as in FIG. 5A. By way of one example, if the copy function 131 in the home window 136 is selected from the display unit 130 in FIG. 3, the UI screen 137 is changed to the UI screen 137a of FIG. 5A. By way of another example, the UI screen 137 may automatically change to the UI screen 137a of FIG. 5A when loading of the documents on the document feeder 213 of the scan unit 210 is detected.

FIG. 5A illustrates the UI screen 137a where a basic tab in the tab area 510 is selected and that one of selections in the selection area 515 is selected in a selection area 515 under the basic tab. Further, FIG. 5A illustrates that Reduce/Enlarge Original (100%) selection is selected in the selection area 515, and that output options are displayed in the option area 520a corresponding to the Reduce/Enlarge Original (100%) selection. If one of the output options is selected from the displayed tab area 510 and the option area 520a and the preview selection menu 550 is selected, the sample image preview corresponding to the sample image is displayed in the preview area 540a reflecting the selected output option. The sample image preview may be displayed as a default even if a user does not select the preview selection menu 550. Display/non-display of the sample image preview as the default may be set by a user or an administrator.

The tab area 510 may be changed by selecting among the basic tab, the advanced tab and the image tab. When the tab area 510 is changed, the option area 520 is also changed to correspond to the changed tab area. When the selected tab area 510 and the option area 520 are changed, the sample image preview reflecting the changed option in the selected tab area 510 and/or the option area 520 may be displayed in the preview area 540a.

FIG. 5A also illustrates a sample image preview displayed on the display unit 130 when the original (100%) option is selected from reduce/enlarge option of the document in the option area 520 under the basic tab area 510. Further, the output grayscale option 525 may be manipulated to set the darkness of the output.

FIG. 5B illustrates the UI screen 137b where the basic tab is selected in the tab area 510, and the Color Mode Auto selection is selected in the selection area 515a. The UI screen 137b may be displayed, for example, if the Color Mode Auto selection is selected from the UI screen 137a of FIG. 5A. Under the basic tab and the Color Mode Auto selection, color options are displayed in the option area 520b. FIG. 5B also illustrates a sample image preview which is displayed in the preview area 540b on the display unit when the color red is selected from single color in a color mode option in the option area 520.

FIG. 5C illustrates the UI screen 137c showing options in the option area 520 when the advanced tab is selected in the tab area 510. The UI screen 137c may be displayed, for example, if the advanced tab is selected from the UI screen 137a of FIG. 5A or the UI screen 137b of FIG. 5B. In this example, an N-up option is selected under the selection area 515c. The N-up option represents the number of pages N displayed in a single display according to the options selected in FIGS. 5A and 5B. If a 4-up is selected in the option area 520c under the advanced tab and the N-up option, as illustrated in FIG. C with respect to a sample image of four pages to which the color red applies among single color, as illustrated in FIG. 5B, a display of four pages which is changed into red color is displayed in a single display in the preview area 540c.

To display the sample image preview as in FIG. 5C, the image processor 160 may need to process an image. For example, in the case of an option which requires image processing, the image processor 160 reduces the size of the sample image corresponding to the option from 100% to 25%, generates a sample image based on the reduced size and displays a sample image preview corresponding to the generated sample image in the preview area 540.

According to another exemplary embodiment, the sample image preview may be displayed in a pop-up window as illustrated in FIG. 5D. FIG. 5D illustrates a UI screen 137d with a pop-up window 560 displaying the sample image preview. The UI screen 137d may be displayed with the pop-up window 560, for example, if the preview area 540c of FIG. 5C is double clicked in the UI screen 137c. In the example illustrated in FIG. 5D, the pop-up window 560 displays a larger view of the sample image preview 540d. The close button 561 may be selected to close the pop-up window 560. The N-up display 563 displays the number of pages displayed, and the number of pages displayed may be controlled by the increase option 565 and the decrease option 567, which may be selected to increase and decrease the number of pages displayed, respectively. The UI screen 137d may also include the option area 520d, which may be partially covered by the pop-up window 560.

Referring back to FIG. 4, the displayed sample image preview is exposed to a user. The user input may then be received through the OPE 120 or through the touch panel of the display unit 130 and it is determined whether to scan the document or not, at operation S440. If, for example, the displayed sample image preview is not the same as the desired result of the output, it may be determined not to scan the document and the operation S420 is performed again to change the preset option. For example, the user may view the displayed sample image preview, and determine to scan the document if the user is satisfied with the sample image preview. If the user is not satisfied with the sample image preview, the user may determine not to scan the document and change the preset option to make changes to the sample image preview.

If it is determined to scan the document, the document loaded on the scan unit 210 is scanned, and the document image corresponding to the document is generated at operation S450. By way of example, scanning of the document may begin if the start button 125 of the OPE 120 is selected when any of the UI screens 137a, 137b, 137c, 137d of FIGS. 5A-5D is displayed on the display unit 130.

The generated document image may be temporarily stored in a storage medium such as the RAM 153 or the HDD 140, and may be processed by the image processor 160 according to the preset option to generate a real image. The generated real image is displayed in an area of the display unit 130 at operation S460, and may be enlarged or reduced according to the size of the area of the display unit 130. According to another exemplary embodiment, the real image preview may be displayed as a pop-up window.

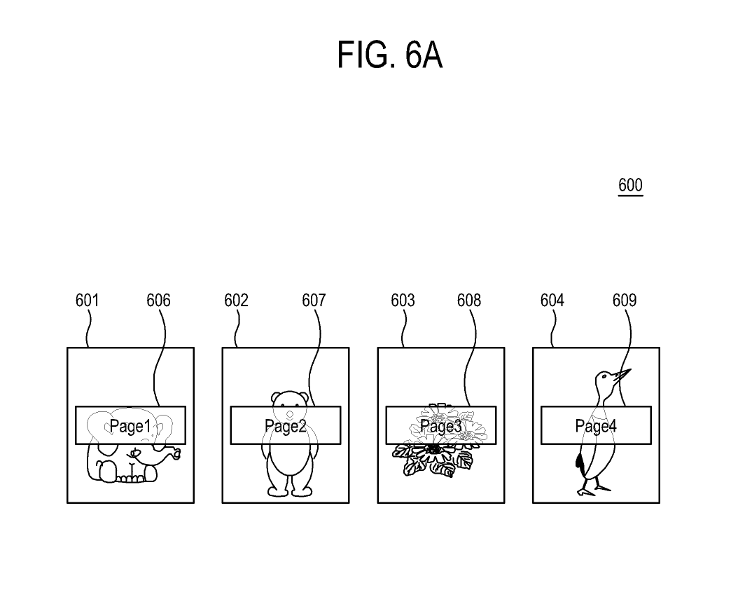

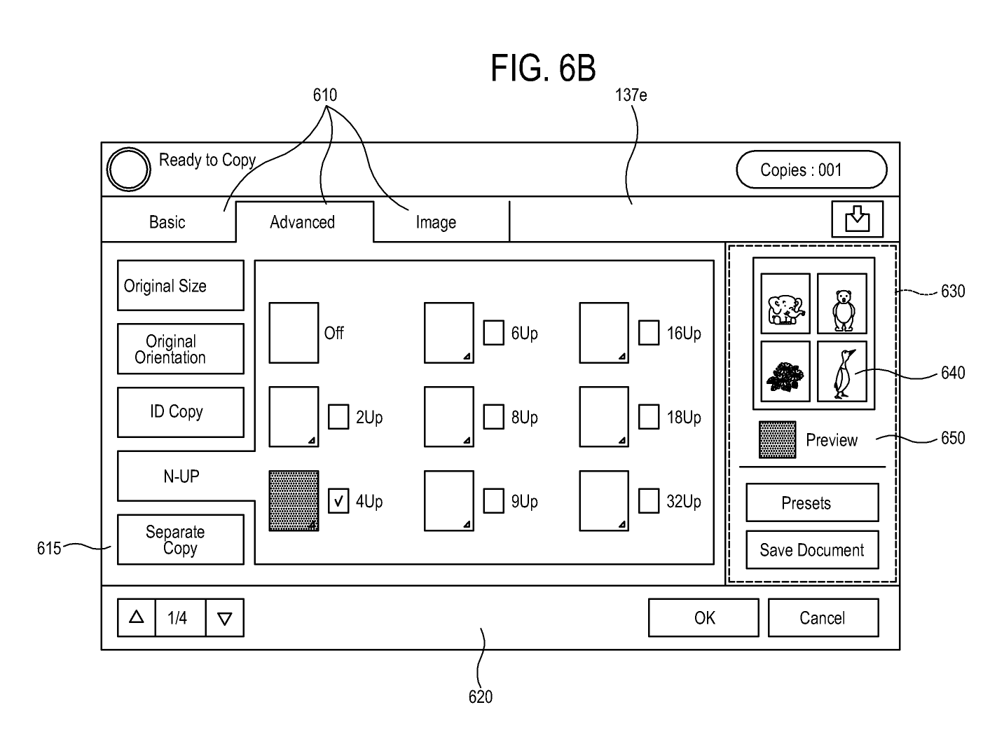

FIGS. 6A to 6B illustrate an example of a document and a real image preview corresponding to a document image according to the exemplary embodiment of the present general inventive concept.

Referring to FIG. 6A, an example of four page documents 600 is displayed. The four pages of the documents 601, 602, 603 and 604 are labeled with the respective page numbers 606, 607, 608 and 609 after being scanned. The single color red and the 4-up option apply to the four-page document to generate a real image, which were similarly applied in the example of FIGS. 5A-5C, and a real image preview corresponding to the generated real image is displayed in the preview area 640 of FIG. 6B.

FIG. 6B illustrates a UI screen 137e where the real image preview is displayed in the preview area 640 by applying the option in FIG. 5C to the real image of the document. The UI screen 137e may be automatically displayed after scanning of the document is complete. The UI screen 137e displays a tab area 610 having a basic tab, an advanced tab and an image tab. In FIG. 6B, the basic tab is selected in the tab area 610, and the N-up option of the selection area 615 is selected. Under the N-up option, 4 Up is selected in the option area 620, as illustrated in FIG. 6B, and thus four pages of the scanned documents are displayed in the preview area 640 of a preview display area 630 when a preview selection menu 650 is selected. Although not shown, the user may also select different tabs in the tab area 610 to set different options under each tab. If the final output is determined, a user may press the start button 125 of the OPE 120 to start outputting the real image to the recording medium.

Then, referring back to FIG. 4, it is determined whether to output the real image at operation S470. If the displayed real image preview is not the same as the desired result of the output, the operation is ended. For example, the user may view the displayed real image preview and determine whether the real image preview is satisfactory. If the user determines the real image preview satisfactory, the user may determine to output the real image to the recording medium.

The document is output by receiving the input of the start button 125 of the OPE 120 or the input of the touch panel of the display unit 130 corresponding to the start button 125 at operation S480.

The output of the real image is generated according to the selected function. The generated output of the real image may be output to the recording medium, transmitted to an external server by a file containing the generated output, transmitted to an external device by attaching the generated output to an e-mail or transmitted by fax to a receiving fax machine. In the output unit 180, the file transmitter 182 and the e-mail transmitter 184 may transmit image data to the server 10, the PC 20, the digital MFP 30 or the printer 40 through the interface 170 by a control of the controller 150.

The output real image may be stored in a storage medium such as the HDD 140. The stored real image may have a file name, which may be used to search the real image. The stored real image may be accessed to output the real image again.

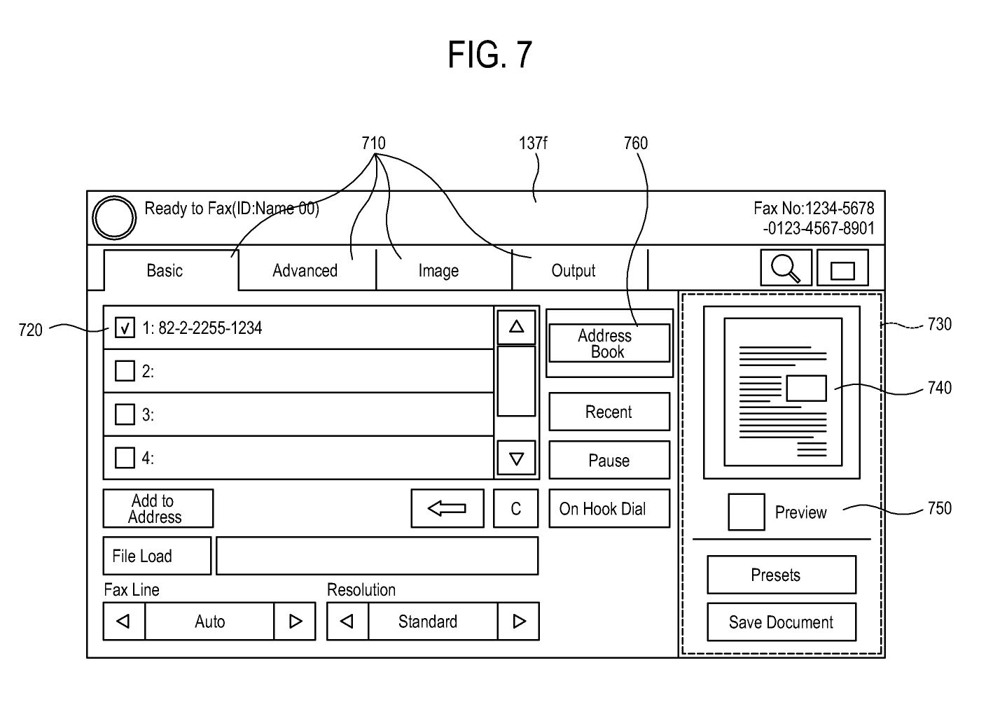

FIG. 7 illustrates a UI screen 137f displaying an example of a real image preview which is transmitted by fax according to the exemplary embodiment of the present general inventive concept.

If the fax function 133 is selected from the home window 136 of the display unit 130, the screen may be changed to the UI screen 137f as illustrated in FIG. 7. By way of an example, if the user selects the start button 125 of the OPE 120 when the UI screen 137e of FIG. 6B is displayed, the UI screen 137e may change to the UI screen 137 of FIG. 3 such that the user can select the fax function 133. The UI in FIG. 7 has a tab area 710 including a basic tab, an advanced tab, an image tab, and an output tab. Under the basic tab in the tab area 710, a receiver telephone number 720 may be input through the OPE 120 or the touch panel The receiver telephone number 720 may also be displayed in the preview area 740 of the preview display area 730 according to the option for the document to be transmitted by fax. Also, a preview selection menu 750 is provided to select a display/non-display of the real image preview in the preview area 740. Depending upon the scanning, the sample image preview or the real image preview is displayed. If the image processing is required at least due to the selected functions or options, for example, the image may be displayed in the preview area 740 after being processed by the image processor 160.

If an address book 760 is selected, a single document may be transmitted to a plurality of recipients by fax. Also, various options may be set by using a plurality of tabs available in the tab area 710.

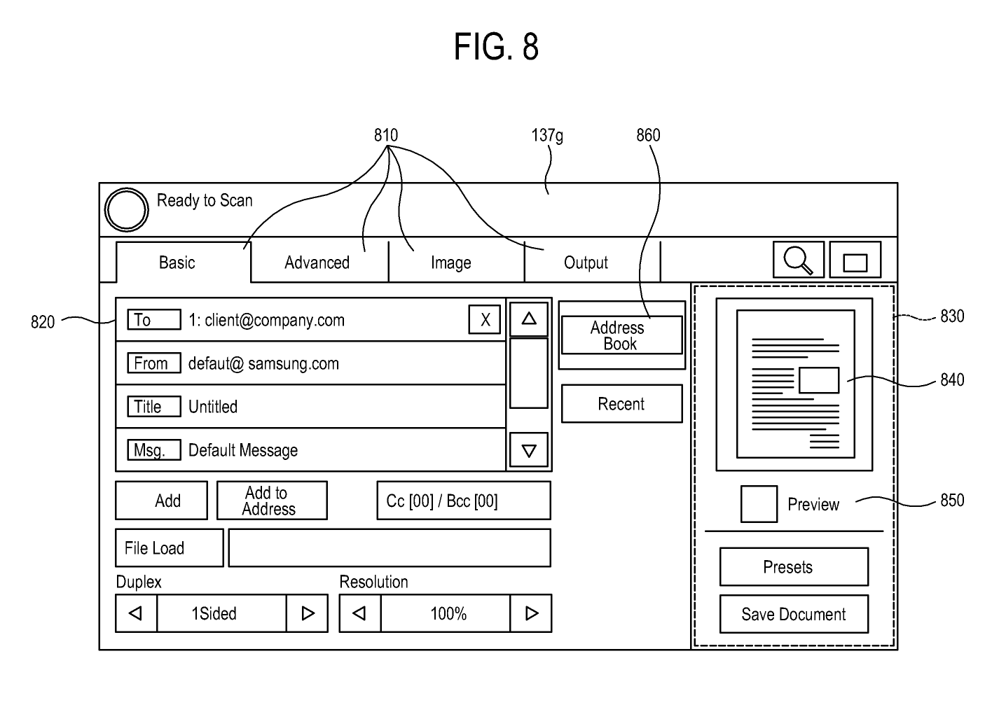

FIG. 8 illustrates a UI screen 137g displaying an example of a real image preview which is transmitted by e-mail according to the exemplary embodiment of the present general inventive concept.

If the transmit file function 132 is selected from the home window 136 of the display unit 130, the screen may be changed to the UI screen 137g as illustrated in FIG. 8. By way of an example, if the user selects the start button 125 of the OPE 120 when the UI screen 137e of FIG. 6B is displayed, the UI screen 137e may change to the UI screen 137 of FIG. 3 such that the user can select the transmit file function 132. The UI screen 137g in FIG. 8 has a tab area 810 including a basic tab, an advanced tab, an image tab, and an output tab. Under the basic tab of the tab area 810, the e-mail message area 820 has areas to input the recipient's e-mail address, the sender's e-mail address, the title of the e-mail and the e-mail message. To enter an e-mail address in the e-mail message area 820, at least one of e-mail addresses which are recorded in the address book 860 may be selected or at least one e-mail address may be input by a user through a soft keyboard (not shown). The recipient's e-mail address may also be displayed in the preview area 840 of the preview display area 830 according to the option for the document to be transmitted by fax. Also, a preview selection menu 850 is provided to select a display/non-display of the real image preview in the preview area 840.

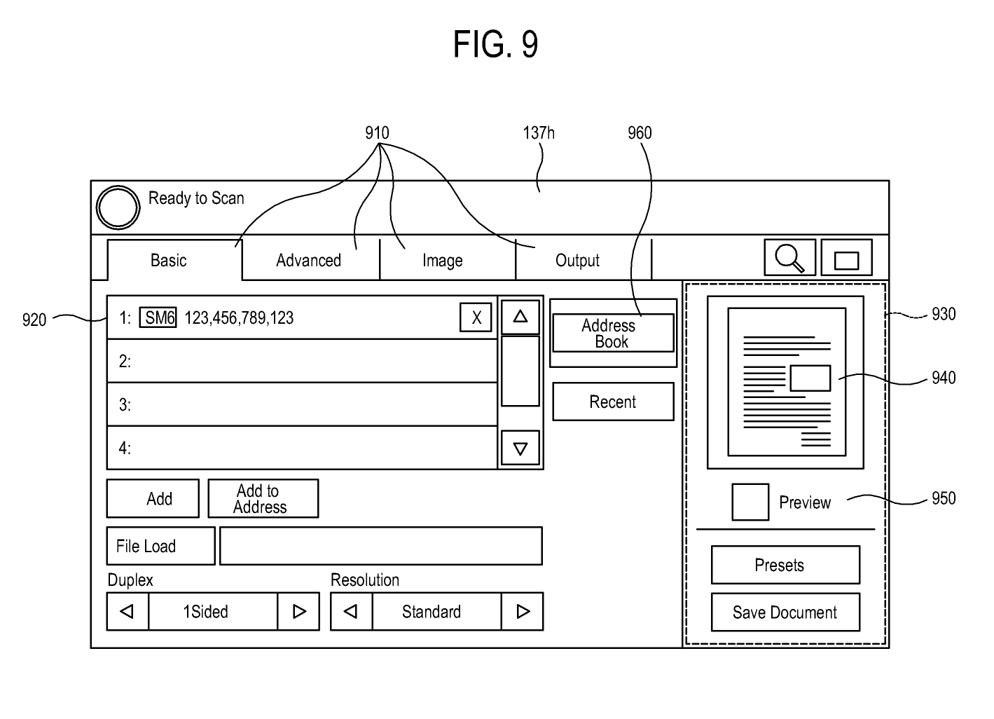

FIG. 9 illustrates an example of a real image preview which is transmitted by a file according to the exemplary embodiment of the present general inventive concept.

If the transmit file function 132 is selected from the home window 136 of the display unit 130, the screen may be changed to the UI screen 137h as illustrated in FIG. 9. By way of an example, if the user selects the start button 125 of the OPE 120 when the UI screen 137e of FIG. 6B is displayed, the UI screen 137e may change to the UI screen 137 of FIG. 3 such that the user can select the transmit file function 132. The UI screen 137h in FIG. 9 has a tab area 910 including a basic tab, an advanced tab, an image tab, and an output tab. Under the basic tab of the tab area 910, an IP address area 920 can be used to enter a recipient's IP address. At least one IP address recorded in an address book 960 or an address corresponding to the IP address is input. For example, the address may include FTP address information, domain name, etc. At least one address information may be input by a user by using a soft keyboard (not shown). Further, the recipient's IP address may also be displayed in the preview area 940 of the preview display area 930 according to the option for the document to be transmitted by fax. Also, a preview selection menu 950 is provided to select a display/non-display of the real image preview in the preview area 940.

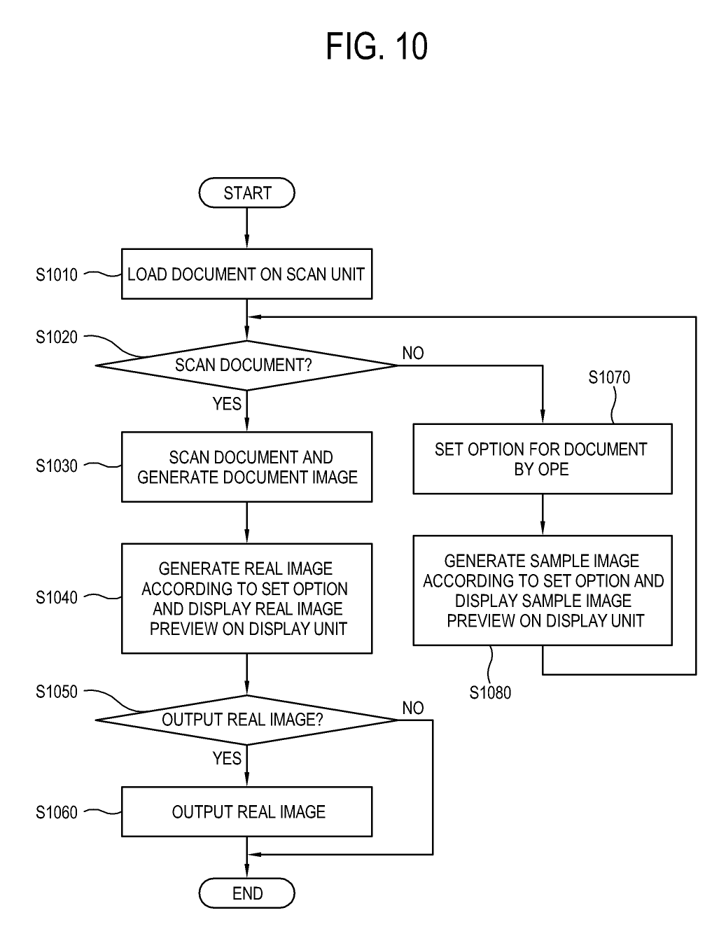

FIG. 10 is a flowchart of a method for controlling an output of an image forming apparatus according to another exemplary embodiment of the present general inventive concept.

Referring to FIG. 10, a document including one or more pages of the document is loaded on the document feeder 213 of the scan unit 210 at operation S1010. The document loaded on the document feeder 213 is then loaded on the document feeder 213 of the ADF 212 or the scan glass 215. The loading of the document may be detected by a paper detecting sensor (not shown) or the image sensor unit 220 as in FIG. 2.

Then, it is determined whether to scan the loaded document or not, at operation S1020. This determination may be based on a user input, which may select to scan or not to scan the loaded document, for example.

If it is determined to scan the document, the document loaded on the scan unit 210 is scanned and the document image is generated corresponding to the document at operation S1030.

The generated document image may be temporarily stored in a storage medium such as the RAM 153 or the HDD 140, and the image processor 160 may process the image according to the preset option to generate the real image. The real image preview of the generated real image is displayed in the area of the display unit 130 at operation S1040, and may be enlarged or reduced according to the size of the real image and/or the size of the area of the display unit 130. According to another exemplary embodiment of the present general inventive concept, the real image preview may be displayed in a pop-up window.

An example of the real image preview according to this exemplary embodiment of the present general inventive concept may also be illustrated in FIGS. 6A to 6B.

Then, it is determined whether to output the real image at operation S1050. If the displayed real image preview is not the same as the desired result of the output, the operation is ended. For example, the user may view the displayed real image preview and determine whether the real image preview is satisfactory. If the user determines the real image preview satisfactory, the user may determine to output the real image to the recording medium.

The document is output by receiving the input of the start button 125 of the OPE 120 or the input of the touch panel of the display unit 130 corresponding to the start button 125 at operation S1060.

If it is determined not to scan the document, the at least one of the functions displayed on the display unit 130 of the image forming apparatus 100 is selected by a user's input through the OPE 120 or the touch panel. The screen of the display unit 130 is changed into the UI screen corresponding to the selected function. Then, at least one option is set by a user from the changed UI screen at operation S1070.

To identify the result of the output, the sample image is generated according to the set option (and stored in the HDD 140), and the sample image preview corresponding to the sample image stored in the HDD 140 reflecting the set option is displayed in the area of the display unit 130 at operation S1080. If the stored sample image is selected according to the set option or the selected sample image should be processed, the sample image preview corresponding to the sample image processed by the image processor 160 by a control of the controller 150 may be displayed on the display unit 130.

The displayed sample image preview is identified by a user, and it is determined whether to scan the document at operation S1020.

According to the exemplary embodiment of the present general inventive concept, the image forming apparatus 100 may be connected to the server 10 or the PC 20 including an exclusive application or a web browser such as Microsoft Internet Explorer™ (MSIE), Firefox™, Opera™, Netscape Navigator™ or the like through the interface 170. According to a request from the connected server 10 or the PC 20, the examples illustrated in FIGS. 3 and 5 through 9 displayed on the display unit 130 of the image forming apparatus 100 may be provided equivalently. A user of the server 10 or the PC 20 may identify the progress of the operation of the image forming apparatus 100 in real-time through the provided screen.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, DVDs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, an image forming apparatus and a method for controlling an output thereof according to the present general inventive concept outputs a document after identifying a result of an output through a sample image preview and a real image preview.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. A method of controlling an output of an image forming apparatus, the method comprising:
loading a document through a scan unit;
setting an option for the document through an operation panel unit;
displaying a sample image preview corresponding to a sample image on a display unit by using the sample image reflecting the set option;
generating a document image by scanning the document;
generating a real image by applying the set option to the document image; and
displaying on the display unit a real image preview corresponding to the real image.

2. The method according to claim 1, further comprising outputting the real image, wherein the outputting comprises at least one of:
printing the real image on a recording medium;
transmitting an e-mail with the real image attached thereto to an external device;
transmitting by fax the real image to a receiving fax machine; and
transmitting the real image to an external server.

3. The method according to claim 1, wherein at least one of the sample image and the real image is scaled to be consistent with a display area of the display unit in which a preview is displayed.

4. The method according to claim 1, wherein the scan unit comprises at least one of a scan glass and an auto document feeder which load the document thereon.

5. The method according to claim 2, further comprising:
selecting a function corresponding to at least one of the printing, the transmitting of an e-mail, the transmitting by fax and the transmitting to the external server.

6. The method according to claim 5, wherein the outputting comprises outputting the real image corresponding to the selected function.

7. The method according to claim 1, wherein the displaying the sample image preview comprises processing the sample image according to the set option.

8. The method according to claim 1, wherein the display unit displays at least one of the sample image preview and the real image preview in a pop-up window.

9. The method according to claim 1, further comprising providing at least one of the sample image preview and the real image preview to an external device.

10. A method of controlling an output of an image processing apparatus, the method comprising:
determining whether to scan a document;
receiving a selection to set an option for the document;
displaying a sample image preview corresponding to a sample image on a display unit by using the sample image having the set option if the document is not scanned yet;
generating a real image by applying the set option to a document image generated by scanning the document; and
displaying on the display unit a real image preview corresponding to the real image if the document is scanned.

11. The method according to claim 10, further comprising outputting the real image corresponding to at least one of functions which are used to output the real image.

12. The method according to claim 10, wherein the displaying the real image preview comprises processing the sample image according to the set option.

13. An image forming apparatus comprising:
a scan unit which generates a document image by scanning a document;
an interface which is connected to an external device;
an operation panel unit which receives an input to set an option for generating the document image;
a storage unit which stores therein a sample image corresponding to the set option and the document image;
an image processor which processes the document image according to the set option which is input through the operation panel unit to generate a real image;
a display unit which displays thereon a preview using the sample image and the real image; and
a controller which controls the display unit to selectively display the preview depending on whether the document is scanned.

14. The image forming apparatus according to claim 13, further comprising an output unit which outputs the real image,
wherein the output unit comprises at least one of:
an image forming unit which prints the real image on a recording medium;
an e-mail transmitter which transmits an e-mail with the real image attached thereto to an external device;
a fax unit which transmits by fax the real image to a receiving fax machine; and
a file transmitter which transmits the real image to an external server.

15. The image forming apparatus according to claim 13, wherein the scan unit comprises at least one of a scan glass on which the document is manually fed, and an auto document feeder which automatically feeds the document.

16. The image forming apparatus according to claim 13, wherein at least one of the sample image preview and the real image preview is supplied to an external device through the interface.

17. The image forming apparatus according to claim 13, wherein the display unit comprises a preview area in which at least one of the sample image and the real image is displayed, and at least one of the sample image and the real image is scaled according to the preview area.

18. A method of controlling an output of an image forming apparatus, the method comprising:
loading a document through a scan unit;
displaying on a display unit a sample image preview corresponding to a sample image by using a prestored sample image;
generating a document image by scanning the document;
generating a real image based on the document image; and
displaying on the display unit a real image preview corresponding to the real image.

19. The method according to claim 18, wherein at least one of the sample image preview and the real image preview is displayed as a default set for the image forming apparatus.

20. The method according to claim 18, further comprising outputting the real image, wherein the outputting comprises at least one of:
printing the real image on a recording medium;
transmitting the real image as an attachment to an e-mail to an external device;
transmitting the real image by fax to a receiving fax machine; and
transmitting the real image to an external server.

21. The method according to claim 20, further comprising selecting a function corresponding to at least one of the printing, the transmitting as the attachment to the email, the transmitting by fax and the transmitting to the external server, wherein the outputting comprises outputting the real image corresponding to the selected function.

22. A method of controlling an output of an image forming apparatus, the method comprising:
loading a document through a scan unit;
generating a document image by scanning the document;
generating a real image based on the document image;
displaying on a display unit a real image preview corresponding to the real image; and
outputting the real image.

23. The method according to claim 22, further comprising receiving an input to set an option of the document through an operation panel unit, wherein the real image is generated by applying the set option thereto.

24. An image forming apparatus, comprising:
a scan unit to scan a document to generate a real image;
an operation control unit to set at least one option and to generate a sample image interface including a sample image preview according to the set at least one option and a sample image and to generate a real image interface including a real image preview according to the set at least one option and the real image; and
an output unit to output the real image according to the real image preview and the set at least one option.

25. The image forming apparatus of claim 24, wherein the operation control unit comprises:
a display unit configured to:
display an option interface to present the at least one option,
display the sample image interface to present the sample image preview based on the set at least one option, and
display the real image interface to present the real image preview based on the set at least one option.

26. The image forming apparatus of claim 24, wherein the operation control unit comprises:
an operation panel unit to receive an input to set the at least one option and to control the scan unit.

27. The image forming apparatus of claim 24, further comprising:
an image processor to process the sample image and the real image according to the set at least one option.

28. The image forming apparatus of claim 24, wherein the output unit comprises at least one of:
an image forming unit configured to print the real image on a recording medium;
an e-mail transmitter configured to transmit an e-mail with the real image attached thereto to an external device;
a fax unit configured to transmit by fax the real image to a receiving fax machine; and
a file transmitter configured to transmit the real image to an external server.
